(19) United States
(12) Patent Application Publication
(10) Pub. No.: US 2011/0095856 A1
(43) Pub. Date: Apr. 28, 2011

(54) MULTI LAYER INDUCTOR AND METHOD FOR MANUFACTURING THE SAME

(75) Inventors: Takashi Nakajima, Takasaki-shi (JP); Kenji Okabe, Takasaki-shi (JP); Kenitirou Nogi, Takasaki-shi (JP); Yoshiaki Kamiyama, Takasaki-shi (JP); Tomomi Kobayashi, Takasaki-shi (JP); Yoshikazu Okino, Takasaki-shi (JP)

(73) Assignee: Taiyo Yuden Co., Ltd.

(21) Appl. No.: 12/991,687

(22) PCT Filed: May 7, 2009
(86) PCT No.: PCT/JP2009/058960

§ 371 Date: Nov. 8, 2010

(30) Foreign Application Priority Data
May 9, 2008 (JP) 2008-123947

(51) Int. Cl. H01F 17/00; H01F 41/00

(52) U.S. Cl. 336/177; 29/602.1

(57) ABSTRACT

A multi layer inductor using an Ni—Zn—Cu ferrite, which has an improved temperature characteristic and is free from structural defects, is provided, and a method for manufacturing the multi layer inductor is also provided. The multi layer inductor is characterized by including a laminate 1 having a rectangular parallelepiped shape, which is provided with a plurality of magnetic layers 3,3 composed of an Ni—Zn—Cu ferrite, a plurality of conductor layers 2,2 forming a coil upon being laminated via the magnetic layers and at least one non-magnetic layer 4 formed so as to come into contact with the plurality of magnetic layers 3,3 and composed of a Ti—Ni—Cu—Mn—Zr-based dielectric substance; and at least a pair of external electrodes 7,7 provided on the ends of the laminate 1 and conductively connected to the ends of the coil.

### TECHNICAL FIELD

The present invention relates to a multi layer inductor, in particular, a multi layer power choke coil which is used for DC/DC convertors.

### BACKGROUND ART

Important product characteristics in a power choke coil of power source applications such as DC/DC convertors include an overlay characteristic.

In a multi layer power choke, there is taken a technique in which in an area where magnetic fluxes are concentrated, a non-magnetic layer is formed by simultaneous calcination with a magnetic layer to suppress magnetic saturation, thereby enhancing the overlay characteristic.

As one of such techniques, Patent Documents 1 and 2 describe that the non-magnetic layer is made of, for example, a Zn—Cu ferrite, constituent elements of which are close to those of an Ni—Zn—Cu ferrite constituting the magnetic layer.

Also, Patent Document 3 describes that a ceramic made of any one of ZnFe₂O₄, TiO₂, WO₂, Ta₂O₅, a cordierite-based ceramic, a BaSnN-based ceramic and a CaMgSiAlB-based ceramic is used for the non-magnetic layer.

But, in Patent Document 3, it is not described that the Ni—Zn—Cu ferrite is used for the magnetic layer; and only ZnFe₂O₄ (zinc ferrite) is specifically described for the non-magnetic layer, but TiO₂ is not specifically described.

On the other hand, Patent Document 4 describes a “dielectric substance porcelain composition composed of a blend of TiO₂ with from 0.1 to 10 wt % of ZrO₂, from 1.5 to 6.0 wt % of CuO, from 0.2 to 20 wt % of Mn₃O₄ and from 2.0 to 15 wt % of NiO, with a total sum thereof being 100 wt %”; and Patent Document 5 describes a “dielectric substance porcelain composition composed of a blend of TiO₂ with from 0.1 to 10 wt % of ZrO₂, from 1.5 to 5.0 wt % of CuO and from 0.2 to 15.0 wt % of Mn₃O₄, with a total sum thereof being 100 wt %”. However, all of these patent documents merely suggest that such a dielectric substance porcelain composition is used as the material of a condenser part of an inductor/condenser composite component but do not show that the composition is used for the non-magnetic layer of a multi layer inductor.

However, as described in Patent Documents 1 and 2, in the case where the non-magnetic layer is made of a Zn—Cu ferrite, at the simultaneous calcination, the Zn component of the Zn—Cu ferrite is diffused into the Ni—Zn—Cu ferrite, whereas the Ni component of the Ni—Zn—Cu ferrite is diffused into the Zn—Cu ferrite, and as a result, an Ni—Zn—Cu ferrite layer where the Ni concentration varies in a gradient manner is formed; and the diffusion layer is composed of an Ni—Zn—Cu ferrite in which a curie point varies following the Ni concentration gradient, and following an increase of the temperature, the magnetic material is changed to the non-magnetic material from an area where the Ni concentration is low. In consequence, there was involved such a problem that since an apparent thickness of the non-magnetic layer varies depending upon the temperature, a temperature characteristic of the product deteriorates.

Also, as described in Patent Document 2, for example, when TiO₂ is used as a ceramic constituting the non-magnetic layer, since a sintering temperature of TiO₂ is higher than a melting point of Ag, it was difficult to achieve the simultaneous calcination with an internal conductor made of Ag; or since a crack is easily generated at the interface with the Ni—Zn—Cu ferrite, in the case of using the Ni—Zn—Cu ferrite as the magnetic layer, it was difficult to use TiO₂.

Patent Document 1: JP-A-Hei11-97245

Patent Document 2: JP-A-2001-44037

Patent Document 3: JP-A-Hei11-97256

Patent Document 4: Japanese Patent No. 2977632

Patent Document 5: Japanese Patent No. 3272740

### DISCLOSURE OF THE INVENTION

### Problem to be Solved by the Invention

In view of the foregoing circumstances, the present invention has been made, and an object thereof is to provide a multi layer inductor using an Ni—Zn—Cu ferrite, which has an improved temperature characteristic and is free from structural defects and also to provide a method for manufacturing a multi layer inductor therefor.

### Means for Solving the Problem

In order to solve the foregoing problems, the present invention adopts the following means.

(1) A multi layer inductor to be used as a choke coil of a power source circuit, comprising a laminate having a rectangular parallelepiped shape, which includes a plurality of magnetic layers composed of an Ni—Cu—Zn ferrite, a plurality of conductor layers forming a coil upon being laminated via the magnetic layers and at least one non-magnetic layer formed so as to come into contact with the plurality of magnetic layers and composed of a Ti—Ni—Cu—Mn—Zr-based dielectric substance; and at least a pair of external electrodes provided on the ends of the laminate and electrically connected to the ends of the coil.

(2) The multi layer inductor as set forth above in (1), wherein in the laminate, the Ni—Zn—Cu ferrite of the magnetic layer and the Ti—Ni—Cu—Mn—Zr-based dielectric substance of the non-magnetic layer are mutually diffused to form a joining interface.

(3) The multi layer inductor as set forth above in (1) or (2), wherein the non-magnetic layer is composed of a dielectric substance containing TiO₂ as a main component and also NiO, CuO, Mn₃O₄ and ZrO₂.

(4) The multi layer inductor as set forth above in (3), wherein the dielectric substance is constituted so as to contain TiO₂, from 2.0 to 15% by mass of NiO, from 1.5 to 6.0% by mass of CuO, from 0.2 to 20% by mass of Mn₃O₄ and from 0.1 to 10% by mass of ZrO₂ in terms of oxide conversion, with a total sum thereof being 100% by mass.

(5) A method for manufacturing a multi layer inductor comprising a step of preparing a paste of a ferrite powder containing Fe₂O₃, NiO, ZnO and CuO; a step of preparing a paste of a dielectric substance powder containing TiO₂ as a main component and also NiO, CuO, Mn₃O₄ and ZrO₂; a step of printing a conductive paste pattern on a magnetic material sheet formed by coating the paste of ferrite powder and laminating and press bonding this in such a manner that not only the conductive paste patterns between the magnetic material sheets vertically contacting each other are connected to each other via through-holes, thereby constituting a spiral-shaped coil, but at least one non-magnetic sheet formed by coating of the paste of dielectric substance powder or non-magnetic pattern formed by printing of the paste of dielectric substance powder is inserted therebetween, thereby forming an uncalcined laminate; and a step of calcining this uncalcined laminate to obtain a laminate.

(6) A method for manufacturing a multi layer inductor comprising a step of preparing a paste of a ferrite powder containing Fe₂O₃, NiO, ZnO and CuO; a step of preparing a paste of a dielectric substance powder containing TiO₂ as a main component and also NiO, CuO, Mn₃O₄ and ZrO₂; a step of performing printing of a conductive paste pattern on a magnetic material sheet formed by coating the paste of ferrite powder and printing of the paste of the ferrite powder for the purpose of obtaining a magnetic material paste pattern alternately in such a manner that at least one non-magnetic pattern formed by printing of the paste of dielectric substance powder is inserted therebetween, thereby forming an uncalcined laminate; and a step of calcining this uncalcined laminate to obtain a laminate.

(7) The method for manufacturing a multi layer inductor as set forth above in (5) or (6), wherein the step of calcining the uncalcined laminate to obtain a laminate is to form a joining interface by mutually diffusing an Ni—Zn—Cu ferrite of the magnetic material sheet or magnetic layer formed from a magnetic material paste pattern and a Ti—Ni—Cu—Mn—Zr-based dielectric substance of the non-magnetic sheet or non-magnetic layer formed from a non-magnetic pattern.

(8) The method for manufacturing a multi layer inductor as set forth above in (5) or (6), wherein the dielectric substance powder is a powder constituted so as to contain TiO₂, from 2.0 to 15% by mass of NiO, from 1.5 to 6.0% by mass of CuO, from 0.2 to 20% by mass of Mn₃O₄ and from 0.1 to 10% by mass of ZrO₂ in terms of oxide conversion, with a total sum thereof being 100% by mass.

### Effect of the Invention

According to the present invention, it is possible to provide a multi layer choke coil which has a favorable direct current overlay characteristic, has little change of characteristic due to temperature, and can be stably produced.

The foregoing object and other objects, constitutional characteristic features and actions and effects of the present invention will become clear from the following explanations and accompanying drawings.

### BRIEF DESCRIPTION OF THE DRAWINGS

FIG. 1 is a longitudinal sectional view showing an internal structure of a multi layer inductor of the present invention.

FIG. 2 is an exploded perspective view showing an internal structure of a laminate of a multi layer inductor of the present invention.

FIG. 3 is a partial enlarged view of a section of a region A surrounded by a broken line in FIG. 1 at a laminate interface between a magnetic layer and a non-magnetic layer of a multi layer inductor of the present invention, as prepared on the basis of a photograph taken by a scanning electron microscope (SEM).

FIG. 4 is a graph showing a change of temperature characteristic of inductance in a multi layer inductor of the Example and a multi layer inductor of the Comparative Example.

### DESCRIPTION OF REFERENCE NUMERALS AND SIGNS

1: Laminate

2: Conductor layer for coil (conductive paste pattern)

3: Magnetic layer (magnetic material sheet)

4: Non-magnetic layer (non-magnetic sheet)

5: Through-hole

6: Lead-out part

### BEST MODE FOR CARRYING OUT THE INVENTION

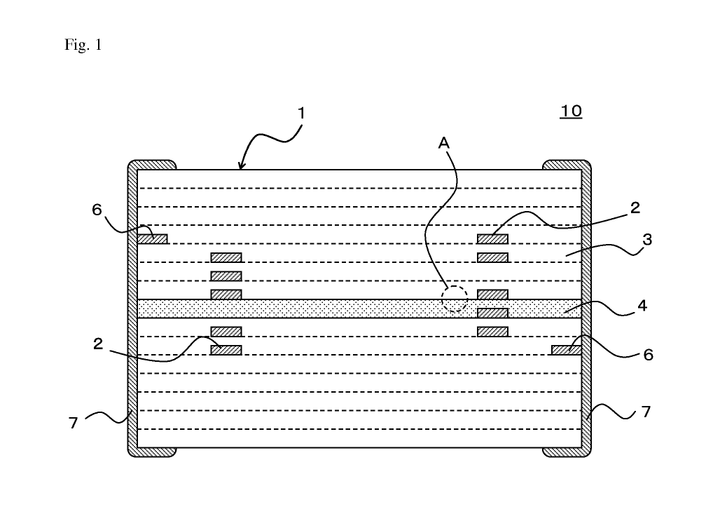

As shown in FIG. 1, a multi layer inductor 10 of an embodiment of the present invention includes a laminate 1 having a rectangular parallelepiped shape and an external electrode 7 made of a metal material such as Ag, etc., which is provided in each end of the laminate 1 in a longitudinal direction thereof.

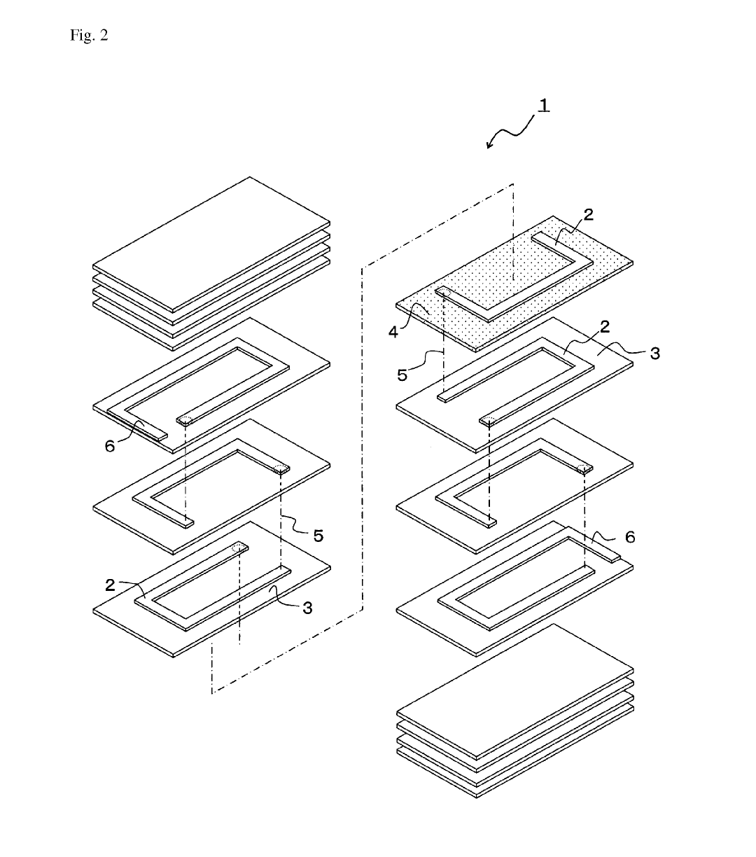

As shown in FIG. 2, the laminate 1 has a structure in which a plurality of conductor layers 2, 2 constituting a coil are laminated via a magnetic layer 3, and a non-magnetic layer 4 is mediated in the center of a lamination direction of the laminate 1 in a mode of replacing at least one of the magnetic layers 3.

In the present invention, the laminate 1 includes the plurality of magnetic layers 3, 3 made of an Ni—Zn—Cu ferrite and the non-magnetic layer 4 made of a Ti—Ni—Cu—Mn—Zr-based dielectric substance. The Ni—Zn—Cu ferrite is a ferrite containing Fe₂O₃, NiO, ZnO and CuO. Also, the Ti—Ni—Cu—Mn—Zr-based dielectric substance is a dielectric substance containing TiO₂ as a main component and also NiO, CuO, Mn₃O₄ and ZrO₂. The non-magnetic layer 4 is a dielectric substance containing TiO₂ as a main component and also NiO, CuO, Mn₃O₄ and ZrO₂ and is preferably a blend of TiO₂ with from 2.0 to 15% by mass of NiO, from 1.5 to 6.0% by mass of CuO, from 0.2 to 20% by mass of Mn₃O₄ and from 0.1 to 10% by mass of ZrO₂, with a total sum thereof being 100% by mass.

By adding CuO and Mn₃O₄ as auxiliaries to the non-magnetic layer 4, on the occasion of calcination, these materials react with a part of TiO₂ to form a Cu—Mn—Ti—O-based liquid phase, and TiO₂ becomes dense at low temperatures by this liquid phase formation, where the growth of grains rapidly proceeds. On the other hand, since ZrO₂ has a high melting point as compared with TiO₂, CuO and Mn₃O₄, when Zr is added to the Cu—Mn—Ti—O-based liquid phase, the melting point and viscosity of the liquid phase increase. As a result, a rate of the grain growth by liquid phase sintering of the TiO₂ grains is adjusted, whereby the non-magnetic layer 4 containing TiO₂ as a main component which is lower in oxygen defects is obtained.

A content of TiO₂ as the main component is preferably 50% by mass or more, and more preferably from 70 to 98% by mass.

Also, the Ni—Zn—Cu ferrite of the magnetic layer 3 and the Ti—Ni—Cu—Mn—Zr-based dielectric substance of the non-magnetic layer 4 are mutually diffused by the simultaneous calcination, thereby forming a joining interface. It is preferable to form a magnetic gap layer by diffusing 0.5μ or more of the Ti—Ni—Cu—Mn—Zr-based dielectric substance into the magnetic layer 3 of the Ni—Zn—Cu ferrite. It may be assumed that Fe₂TiO₅ is formed at the joining interface, thereby forming the magnetic gap layer.

The U-shaped conductor layer 2 for a coil made of a metal material such as Ag, etc. is arranged on an upper side of each of the magnetic layers 3. Also, on each of the magnetic layers 3, through-holes 5, 5 for connecting upper and lower conductor layers for the coil to each other via the magnetic layers 3,3, respectively are formed in such a manner that they are superimposed on the ends of the conductor layers 2,2 for the coil, respectively. The through-holes 5, 5 as referred to herein mean those prepared by filling the same material as in the conductor layer for the coil in a hole previously formed in the magnetic layer. Uppermost and lowermost magnetic layers are those for ensuring upper and lower margins, and neither a conductor layer for the coil nor a through-hole is provided in these magnetic layers.

The U-shaped conductor layer 2 for a coil made of a metal material such as Ag, etc. is arranged on the upper side of the non-magnetic layer 4. Also, on the non-magnetic layer 4, the through-holes 5, 5 for connecting the upper and lower conductor layers 2 for the coil via the non-magnetic layer 4 are formed in such a manner that they are superimposed on the ends of the conductor layers 2,2 for the coil, respectively.

The conductor layers 2, 2 . . . for a coil are connected to each other via the through-holes 5, 5 . . . , thereby constituting a spiral-shaped coil. The uppermost conductor layer 2 for the coil and the lowermost conductive layer 2 for the coil, each of which constitutes the coil, are provided with lead-out parts 6, 6, respectively. One of the respective lead-out parts 6, 6 is connected to one of the external electrodes, and the other is connected to the other external electrode.

Next, a first embodiment of the manufacturing method of the multi layer inductor of the present invention is described.

First, on the occasion of manufacturing a multi layer inductor, a magnetic material sheet (ferrite sheet) for constituting the high-permeability magnetic layer 3 made of an Ni—Zn—Cu ferrite is fabricated. Specifically, a solvent such as ethanol, etc. and a binder such as PVA, etc. are added to and mixed with a ferrite fine powder which has been crushed after pre-calcining and is composed of Fe₂O₃, NiO, CuO and ZnO as main materials, to obtain a ferrite paste, and thereafter, this ferrite paste is coated in a planar form on a film such as PET, etc. by a technique such as a doctor blade method, etc., thereby obtaining a magnetic material sheet (ferrite sheet).

Also, a non-magnetic sheet (dielectric substance sheet) or a non-magnetic pattern for constituting the non-magnetic layer 4 made of a Ti—Ni—Cu—Mn—Zr-based dielectric substance is fabricated. Specifically, similar to the foregoing manner, a solvent and a binder are added to and mixed with a dielectric substance powder containing TiO₂ as a main component and also NiO, CuO, Mn₃O₄ and ZrO₂ to obtain a dielectric substance paste, and thereafter, this dielectric substance paste is coated in a planar form on a film such as PET, etc. by a technique such as a doctor blade method, a slurry build method, etc., thereby obtaining a non-magnetic sheet (dielectric substance sheet), or a non-magnetic pattern by being printed in a pattern shape.

Then, the through-holes 5 are formed in a prescribed arrangement on the magnetic material sheet and the non-magnetic sheet by a technique such as punching by a die, perforation by laser processing, etc. Then, a conductive paste for constituting the conductor layer 2 for a coil is printed in a prescribed pattern on the magnetic material sheet and the non-magnetic sheet after the through-hole formation by a technique such as screen printing, etc. Here, a metal paste containing, for example, Ag as a main component is used for the conductive paste.

Next, the magnetic material sheet and the non-magnetic sheet after printing with a conductive paste are laminated with and press bonded to each other in such a manner that the conductive paste patterns (2) of the upper and lower sheets are connected to each other via the through-hole (5) to constitute a spiral-shaped coil, thereby obtaining a laminate. Here, the magnetic material sheet (3) and the non-magnetic sheet (4) are laminated in an order in which a layer structure as shown in FIG. 2 is obtained.

Then, the sheet laminate is cut in a unit size to obtain a chip-shaped uncalcined laminate. This uncalcined laminate is heated in air at from about 400 to 500° C. for from 1 to 3 hours to remove the binder component, and the uncalcined laminate after removing the binder component is calcined in air at from 850 to 920° C. for from 1 to 3 hours, thereby obtaining a chip-shaped laminate.

For the purpose of forming an external electrode, a conductive paste is coated in each end of the chip-shaped laminate by a technique such as a dip method, etc. Here, the same metal paste as described above, which contains, for example, Ag as a main component, is used for the conductive paste. The laminate after coating the conductive paste is baked in air at from about 500 to 800° C. for from 0.2 to 2 hours, thereby forming an external electrode in each end of the laminate. Finally, the surface of each of the external electrodes is subjected to a plating treatment with Ni, Sn and so on, the illustration of which is omitted, thereby obtaining the multi layer inductor 10.

Next, a second embodiment of the manufacturing method of the multi layer inductor of the present invention is described.

### Illustration Omitted

First, on the occasion of manufacturing a multi layer inductor, a magnetic material sheet (ferrite sheet) for constituting a high-permeability magnetic layer made of an Ni—Zn—Cu ferrite is fabricated. Specifically, a solvent such as ethanol, etc. and a binder such as PVA, etc. are added to and mixed with a ferrite fine powder which has been crushed after pre-calcining and is composed of Fe₂O₃, NiO, CuO and ZnO as main materials, to obtain a ferrite paste, and thereafter, this ferrite paste is coated in a planar form on a film such as PET, etc. by a technique such as a doctor blade method, etc., thereby obtaining a magnetic material sheet (ferrite sheet).

Next, a conductive paste for constituting a conductor layer for a coil is printed in a prescribed pattern on the magnetic material sheet by a technique such as screen printing, etc. Here, a metal paste containing, for example, Ag as a main component is used for the conductive paste.

Next, a magnetic material pattern (ferrite pattern) for constituting a high-permeability magnetic layer made of an Ni—Zn—Cu ferrite is fabricated. Specifically, a solvent such as ethanol, etc. and a binder such as PVA, etc. are added to and mixed with a ferrite fine powder which has been crushed after pre-calcining and is composed of Fe₂O₃, NiO, CuO and ZnO as main materials, to obtain a magnetic material paste (ferrite paste), and thereafter, this ferrite paste is printed on the above-formed conductor pattern in such a manner such that one end thereof is exposed, thereby obtaining a magnetic material pattern (ferrite pattern).

Similar to the foregoing manner, a conductive paste for constituting a conductor layer for the coil is printed in a prescribed pattern on the magnetic material pattern by a technique such as screen printing, etc. in such a manner that it is connected to one end of the above-formed conductor pattern.

Similar to the foregoing manner, the magnetic material pattern and the conductor pattern are alternately printed by means of screen printing or the like.

Next, a non-magnetic pattern (dielectric substance pattern) for constituting a non-magnetic layer made of a Ti—Ni—Cu—Mn—Zr-based dielectric substance is fabricated. Specifically, similar to the foregoing manner, a solvent and a binder are added to and mixed with a dielectric substance powder containing TiO₂ as a main component and also NiO, CuO, Mn₃O₄ and ZrO₂ to obtain a dielectric substance paste, and thereafter, this dielectric substance paste is printed in a pattern shape on the above-obtained printed laminate, thereby obtaining a non-magnetic pattern.

Similar to the foregoing manner, the magnetic material pattern and the conductor pattern are alternately printed by means of screen printing or the like.

Then, the obtained printed laminate is cut in a unit size to obtain a chip-shaped uncalcined laminate. This uncalcined laminate is heated in air at from about 400 to 500° C. for from 1 to 3 hours to remove the binder component, and the uncalcined laminate after removing the binder component is calcined in air at from 850 to 920° C. for from 1 to 3 hours, thereby obtaining a chip-shaped laminate.

For the purpose of forming an external electrode, a conductive paste is coated in each end of the chip-shaped laminate by a technique such as a dip method, etc. Here, the same metal paste as described above, which contains, for example, Ag as a main component, is used for the conductive paste. The laminate after coating the conductive paste is baked in air at from about 500 to 800° C. for from 0.2 to 2 hours, thereby forming an external electrode in each end of the laminate. Finally, the surface of each of the external electrodes is subjected to a plating treatment with Ni, Sn and so on, thereby obtaining the multi layer inductor.

### EXAMPLE

The present invention is hereunder described in more detail with reference to the following Example.

Ethanol (solvent) and a PVA-based binder were added to and mixed with a powder of an Ni—Zn—Cu ferrite having a composition shown in Table 1, and the mixture was coated on a PET film to obtain a magnetic material sheet (magnetic layer). Also, the same solvent and binder were added to and mixed with a powder of a dielectric substance containing TiO₂ as a main component and also NiO, CuO, Mn₃O₄ and ZrO₂ as shown in Table 1 (this dielectric substance will be referred to as “TiO₂ low-temperature calcined material”), and the mixture was coated on a PET film to obtain a non-magnetic sheet (non-magnetic layer).

An electrode (U-shaped conductor layer for a coil) was printed and laminated on each of the obtained green sheets, thereby fabricating a sheet laminate having the structure shown in FIG. 2 (laminate of the Example, in which the TiO₂ low-temperature calcined material was laminated on the Ni—Zn—Cu ferrite), and the obtained sheet laminate was cut in a unit size, thereby obtaining a chip-shaped uncalcined laminate. The obtained uncalcined laminate was heated at 500° C. for 1 hour to remove the binder component, followed by calcination at 900° C. for 1 hour to obtain a laminate. Thereafter, an Ag external electrode was attached to each end of the laminate, and the resulting laminate was subjected to a plating treatment with Ni and Sn, thereby obtaining a chip-shaped multi layer inductor of the Example.

### COMPARATIVE EXAMPLE

Ethanol (solvent) and a PVA-based binder were added to and mixed with a powder of an Ni—Zn—Cu ferrite having a composition shown in Table 1, and the mixture was coated on a PET film to obtain a magnetic material sheet (magnetic layer). Also, the same solvent and binder were added to and mixed with a powder of a Zn—Cu ferrite as shown in Table 1, and the mixture was coated on a PET film to obtain a non-magnetic sheet (non-magnetic layer).

An electrode (U-shaped conductor layer for a coil) was printed and laminated on each of the obtained green sheets, thereby fabricating a sheet laminate having the structure shown in FIG. 2 (sheet laminate of the Comparative Example, in which the Zn—Cu ferrite was laminated on the Ni—Zn—Cu ferrite), and the obtained sheet laminate was cut in a unit size, thereby obtaining a chip-shaped uncalcined laminate. The obtained uncalcined laminate was heated at 500° C. for 1 hour to remove the binder component, followed by calcination at 900° C. for 1 hour to obtain a laminate. Thereafter, an Ag external electrode was attached to each end of the laminate, and the resulting laminate was subjected to a plating treatment with Ni and Sn, thereby obtaining a chip-shaped multi layer inductor of the Comparative Example.

TABLE 1

| | | | TiO₂ |
|---|---|---|---|
| | | | low-temperature |
| | Ni—Zn—Cu ferrite | Zn—Cu ferrite | calcined material |
| Fe₂O₃ | 66.3 | 65.4 | — |
| NiO | 14.8 | — | 6.3 |
| ZnO | 12.5 | 27.9 | — |
| CuO | 6.4 | 6.7 | 2.7 |
| ZrO₂ | — | — | 0.2 |
| TiO₂ | — | — | 90.3 |
| Mn₃O₄ | — | — | 0.5 |

### Interface Formation

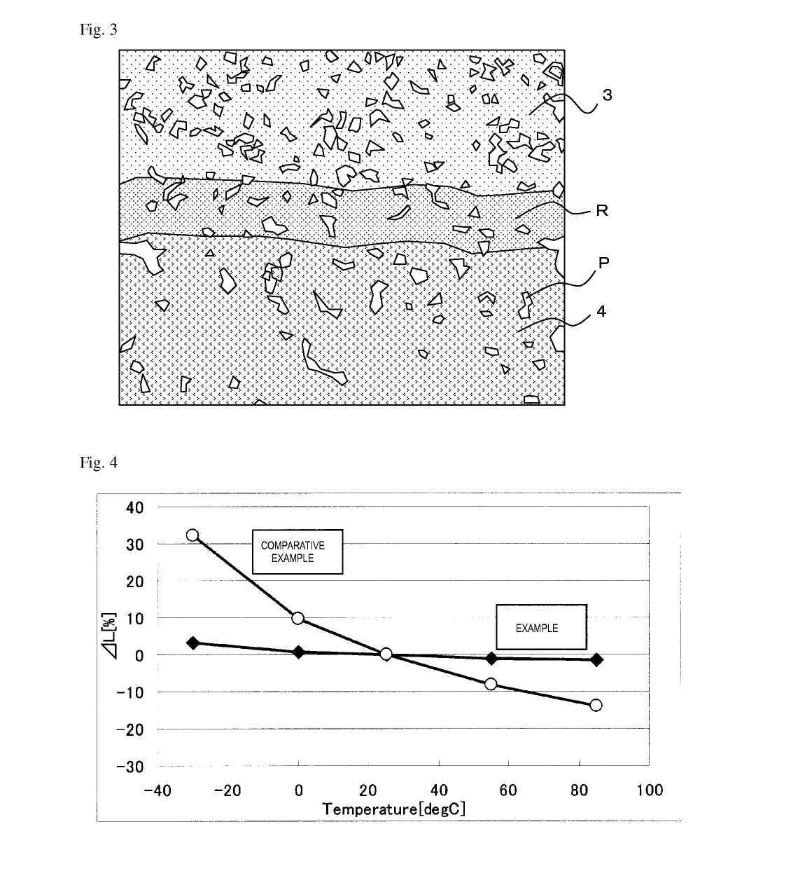

With respect to the above-obtained multi layer inductor of the Example of the present invention, a partial enlarged view of a region A surrounded by a broken line in FIG. 1, as prepared on the basis of a photograph taken by a scanning electron microscope (SEM), is shown in FIG. 3. The magnetic layer 3 made of an Ni—Zn—Cu ferrite and the non-magnetic layer 4 made of a TiO₂ low-temperature calcined material are mutually diffused to form a reaction layer R at the joining interface and joined. In this connection, in FIG. 3, S is a space.

### Temperature Characteristic

A change of temperature characteristic of inductance in the obtained multi layer inductor of the present invention was measured. The characteristic is shown in FIG. 4 along with a characteristic at the time of using a Zn—Cu ferrite for the non-magnetic layer. An amount of rate of change of the inductance by temperature of the multi layer inductor using the TiO₂ low-temperature calcined material according to the present invention for the non-magnetic layer is not more than 10/1 as compared with that of the multi layer inductor using the Zn—Cu ferrite for the non-magnetic layer according to the Comparative Example.

In the light of the above, the multi layer inductor of the present invention was confirmed to have such an effect that not only does it have a favorable DC overlay characteristic, but it does not generate scatter of the temperature characteristic.

1. A multi layer inductor used as a choke coil of a power source circuit being characterized by comprising a laminate having a rectangular parallelepiped shape, which includes a plurality of magnetic layers composed of an Ni—Cu—Zn ferrite, a plurality of conductor layers forming a coil upon being laminated via the magnetic layers and at least one non-magnetic layer formed so as to come into contact with the plurality of magnetic layers and composed of a Ti—Ni—Cu—Mn—Zr-based dielectric substance; and at least a pair of external electrodes provided on the ends of the laminate and conductively connected to the ends of the coil.

2. The multi layer inductor according to claim 1, characterized in that in the laminate, the Ni—Zn—Cu ferrite of the magnetic layer and the Ti—Ni—Cu—Mn—Zr-based dielectric substance of the non-magnetic layer are mutually diffused to form a reaction layer on a joining interface.

3. The multi layer inductor according to claim 1, characterized in that the non-magnetic layer is composed of a dielectric substance containing TiO₂ as a main component and also NiO, CuO, Mn₃O₄ and ZrO₂.

4. The multi layer inductor according to claim 3, characterized in that the dielectric substance is constituted so as to contain TiO₂, from 2.0 to 15% by mass of NiO, from 1.5 to 6.0% by mass of CuO, from 0.2 to 20% by mass of Mn₃O₄ and from 0.1 to 10% by mass of ZrO₂ in terms of oxide conversion, with a total sum thereof being 100% by mass.

5. A method for manufacturing a multi layer inductor, characterized by comprising a step of preparing a paste of a ferrite powder containing Fe₂O₃, NiO, ZnO and CuO; a step of preparing a paste of a dielectric substance powder containing TiO₂ as a main component and also NiO, CuO, Mn₃O₄ and ZrO₂; a step of printing a conductive paste pattern on a magnetic material sheet formed by coating the paste of ferrite powder and laminating and press bonding this in such a manner that not only the conductive paste patterns between the magnetic material sheets vertically contacting each other are connected to each other via through-holes, thereby constituting a spiral-shaped coil, but at least one non-magnetic sheet formed by coating of the paste of dielectric substance powder or non-magnetic pattern formed by printing of the paste of dielectric substance powder is inserted therebetween, thereby forming an uncalcined laminate; and a step of calcining this uncalcined laminate to obtain a laminate.

6. A method for manufacturing a multi layer inductor, characterized by comprising a step of preparing a paste of a ferrite powder containing Fe₂O₃, NiO, ZnO and CuO; a step of preparing a paste of a dielectric substance powder containing TiO₂ as a main component and also NiO, CuO, Mn₃O₄ and ZrO₂; a step of performing printing of a conductive paste pattern on a magnetic material sheet formed by coating the paste of ferrite powder and printing of the paste of the ferrite powder for the purpose of obtaining a magnetic material paste pattern alternately in such a manner that at least one non-magnetic pattern formed by printing of the paste of dielectric substance powder is inserted therebetween, thereby forming an uncalcined laminate; and a step of calcining this uncalcined laminate to obtain a laminate.

7. The method for manufacturing a multi layer inductor according to claim 5, characterized in that the step of calcining the uncalcined laminate to obtain a laminate is to form a joining interface by mutually diffusing an Ni—Zn—Cu ferrite of the magnetic material sheet or magnetic layer formed from a magnetic material paste pattern and a Ti—Ni—Cu—Mn—Zr-based dielectric substance of the non-magnetic sheet or non-magnetic layer formed from a non-magnetic pattern.

8. The method for manufacturing a multi layer inductor according to claim 5, characterized in that the dielectric substance powder is a powder constituted so as to contain TiO₂, from 2.0 to 15% by mass of NiO, from 1.5 to 6.0% by mass of CuO, from 0.2 to 20% by mass of Mn₃O₄ and from 0.1 to 10% by mass of ZrO₂ in terms of oxide conversion, with a total sum thereof being 100% by mass.

9. The multi layer inductor according to claim 2, characterized in that the non-magnetic layer is composed of a dielectric substance containing TiO₂ as a main component and also NiO, CuO, Mn₃O₄ and ZrO₂.

10. The multi layer inductor according to claim 9, characterized in that the dielectric substance is constituted so as to contain TiO₂, from 2.0 to 15% by mass of NiO, from 1.5 to 6.0% by mass of CuO, from 0.2 to 20% by mass of Mn₃O₄ and from 0.1 to 10% by mass of ZrO₂ in terms of oxide conversion, with a total sum thereof being 100% by mass.

11. The method for manufacturing a multi layer inductor according to claim 6, characterized in that the step of calcining the uncalcined laminate to obtain a laminate is to form a joining interface by mutually diffusing an Ni—Zn—Cu ferrite of the magnetic material sheet or magnetic layer formed from a magnetic material paste pattern and a Ti—Ni—Cu—Mn—Zr-based dielectric substance of the non-magnetic sheet or non-magnetic layer formed from a non-magnetic pattern.

12. The method for manufacturing a multi layer inductor according to claim 6, characterized in that the dielectric substance powder is a powder constituted so as to contain TiO₂, from 2.0 to 15% by mass of NiO, from 1.5 to 6.0% by mass of CuO, from 0.2 to 20% by mass of Mn₃O₄ and from 0.1 to 10% by mass of ZrO₂ in terms of oxide conversion, with a total sum thereof being 100% by mass.

13. A multi layer inductor having a rectangular parallelepiped shape constituting a choke coil for a power source circuit, comprising a magnetic body, conductor layers forming a coil embedded in the magnetic body, and at least one non-magnetic layer disposed in the magnetic body,
wherein the magnetic body is made of an Ni—Cu—Zn ferrite, the non-magnetic layer is made of a Ti—Ni—Cu—Mn—Zr dielectric and in contact with the magnetic body, and a magnetic gap layer is formed at a joining interface between the magnetic body and the non-magnetic layer where the Ni—Cu—Zn ferrite and the Ti—Ni—Cu—Mn—Zr dielectric are mutually diffused.

14. The multi layer inductor according to claim 9, wherein the non-magnetic layer is made from a dielectric substance containing TiO₂ in an amount of 70% to 98% by mass of total components for the non-magnetic layer.

15. The multi layer inductor according to claim 9, which exhibits substantially no change of inductance due to temperature.
